(19) United States
(12) Patent Application Publication
(10) Pub. No.: US 2024/0277016 A1
(43) Pub. Date: Aug. 22, 2024

(54) PLANT-BASED FLAVOUR MODIFYING INGREDIENT

(71) Applicant: Givaudan SA, VERNIER (CH)

(72) Inventors: Tarun BHOWMIK, Mason, OH (US); Stefka Ivanova MYAKA, Cincinnati, OH (US); Jenifer AUGELLI, Cranbury, NJ (US); Yosuke ONUMA, Cincinnati, OH (US)

(21) Appl. No.: 18/571,033

(22) PCT Filed: Jul. 1, 2022
(86) PCT No.: PCT/EP22/68261

§ 371 Date: Dec. 15, 2023

Related U.S. Application Data
(63) Continuation of application No. 17/365,193, filed on Jul. 1, 2021.
(60) Provisional application No. 63/287,844, filed on Dec. 9, 2021.

(51) Int. Cl. A23L 27/30; A23G 1/40; A23G 1/56; A23J 3/14; A23J 3/34; A23L 2/02; A23L 2/54; A23L 2/56; A23L 2/60; A23L 11/50; A23L 27/00

(52) U.S. Cl. CPC A23L 27/31; A23G 1/40; A23G 1/56; A23J 3/14; A23J 3/346; A23L 2/02; A23L 2/54; A23L 2/56; A23L 2/60; A23L 11/50; A23L 27/88; A23V 2400/175; A23V 2400/515

(57) ABSTRACT

A method for making a flavour modifying ingredient, the method comprising subjecting a pea protein to enzymatic hydrolysis and fermentation; flavour modifying ingredients obtainable by said method; flavour compositions and food products comprising said flavour modifying ingredient; uses of said flavour modifying ingredient.

### TECHNICAL FIELD

The present invention relates generally to methods for making flavour modifying ingredients using a pea protein and the flavour modifying ingredients made by said methods. The present invention further relates to flavour compositions and food products comprising said flavour modifying ingredients and the uses of said flavour modifying ingredients in food products, for example to improve the mouthfeel, mask off-notes, and/or improve sweetness of food products.

### BACKGROUND

There exists a need in the food industry to provide ingredients which can modify the flavour of various food products, for example to improve the mouthfeel, mask off-notes, and/or improve sweetness. In particular, a need exists to provide flavour modifying ingredients which are natural in order to provide clean-label food products. Novel flavour modifying ingredients and methods for making said flavour modifying ingredients are therefore provided by the present invention.

High-intensity sweeteners (HIS) have a sweetness that can be several hundred times that of low-intensity sweeteners (LIS), such as sucrose. Accordingly, HIS′ can replace a large quantity of LIS′ in a composition, thereby significantly reducing its caloric value. However, these substances generally have the drawback that they may impart undesirable off-tastes to food products, typically bitter, metallic or liquorice tastes, or an undesirable lingering sweetness. Effectively modifying the flavour profile of HIS-containing food products is key to consumer acceptance.

Surprisingly, it has now been found that subjecting a pea protein to the processes described herein, a natural and healthy ingredient can be obtained that has a flavour modifying effect in food products. It has been found that the flavour modifying ingredients made by the processes described herein can modulate the sweetness profile of HIS′ by providing a smoother and more sugar-like sweetness and mouthfeel. This ingredient was also found to modulate the sweetness profile of stevia to more smooth/syrupy when evaluated in a sugar/stevia hybrid base with and without top note. It was also found to mask/modify some of the negative attributes of high-intensity sweeteners in various hybrid systems used in carbonated and uncarbonated soft drinks. These findings enable the use of HIS′ to create healthy clean-label foods and beverages with an improved and cleaner taste and mouthfeel.

### SUMMARY OF THE INVENTION

In accordance with a first aspect of the present invention there is provided a method for making a flavour modifying ingredient, the method comprising subjecting a pea protein to enzymatic hydrolysis and fermentation.

For example, the method of the first aspect of the present invention comprises forming an aqueous slurry of a pea protein or a pea protein base; subjecting the pea protein to enzymatic hydrolysis using one or more proteolytic and/or carbohydrase enzymes to form a pea protein hydrolysate; and subjecting the pea protein hydrolysate to fermentation using one or more lactic acid bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, plantarum, Lactiplantibacillus Lactobacillus brevis, Lactobacillus helveticus, Bifidobacterium, Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019, Streptococcus thermophilus and mixtures thereof, and incubating for a period of time sufficient to ferment at least a portion of the pea protein hydrolysate to form the flavour modifying ingredient.

In certain embodiments, the pea protein is subjected to enzymatic hydrolysis using carbohydrase and/or proteolytic enzymes.

In certain embodiments, the pea protein is selected from the group consisting of: pea protein liquor, pea protein isolate, pea protein concentrate, pea flour, and mixtures thereof.

In certain embodiments, the pea protein is present in an amount of about 1% to about 60% by weight, based on the total weight of the aqueous slurry or the pea protein base. In certain embodiments, the pea protein is present in an amount of about 5% to about 50% by weight, based on the total weight of the aqueous slurry or the pea protein base. In certain embodiments, the pea protein is present in an amount of about 5% to about 40% by weight, based on the total weight of the aqueous slurry or the pea protein base. In certain embodiments, the pea protein is present in an amount of about 10% to about 30% by weight, based on the total weight of the aqueous slurry or the pea protein base.

In certain embodiments, the method of the first aspect of the present invention comprises sterilizing the aqueous slurry or the pea protein base prior to forming the pea protein hydrolysate.

In certain embodiments, the method comprises sterilizing the aqueous slurry or the pea protein base at about 120-125° C. for about 30 minutes, and subsequently allowing the aqueous slurry or the pea protein base to cool down to about 50° C.

In certain embodiments, the one or more proteolytic enzymes are selected from the group consisting of proteinase, peptidase, glutaminase, and mixtures thereof.

In certain embodiments, the one or more proteolytic enzymes comprise both endopeptidase and exopeptidase activity.

In certain embodiments, the one or more proteolytic enzymes comprise an enzyme preparation from Aspergillus oryzae and the hydrolysis is performed at about 40° C. to about 60° C.

In certain embodiments, the method uses two or more proteolytic enzymes.

In certain embodiments, the method uses two or more proteolytic enzymes and one or more amidohydrolase enzymes.

In certain embodiments, the enzymatic hydrolysis takes place for a period of time ranging from about 1 hour to about 48 hours.

In certain embodiments, the method comprises hydrolyzing the pea protein with a first proteolytic enzyme for about 10 to about 20 hours at about 40° C. to 60° C., followed by hydrolyzing the pea protein with a second proteolytic enzyme for about 1 to about 5 hours at about 40° C. to 60° C., wherein the first proteolytic enzyme is different than the second proteolytic enzyme.

In certain embodiments, the method comprises adding the first proteolytic enzyme to the aqueous slurry of pea protein or the pea protein base in an amount of about 0.5% to about 1% by weight, based on the total weight of the aqueous slurry or the pea protein base, and subsequently adding the second proteolytic enzyme to the aqueous slurry of pea protein or the pea protein base in an amount of about 0.01% to about 0.1% by weight, based on the total weight of the aqueous slurry or the pea protein base.

In certain embodiments, the lactic acid bacteria is selected from the group consisting of: Lactobacillus plantarum, Lactobacillus casei, Lactobacillus brevis, Lactobacillus helveticus, L. delbrueckii ssp. bulgaricus, Streptococcus thermophilus, Lactobacillus acidophilus, Bifidobacterium, and combinations thereof.

In certain embodiments, the lactic acid bacteria is added to the aqueous slurry of pea protein or the pea protein base in an amount of about 0.1% to about 1% by weight, based on the total weight of the aqueous slurry or the pea protein base.

In certain embodiments, the method comprises subjecting the pea protein hydrolysate to fermentation for about 5 hours to about 10 hours at about 35° C. to about 40° C.

In certain embodiments, the method comprises sterilizing the aqueous slurry or the pea protein base subsequent to subjecting the pea protein hydrolysate to fermentation.

In accordance with a second aspect of the present invention there is provided a flavour modifying ingredient obtainable by and/or obtained by the method of the first aspect of the present invention, including any embodiment therefore.

In accordance with a third aspect of the present invention there is provided a flavour composition comprising the flavour modifying ingredient of the second aspect of the present invention.

In accordance with a fourth aspect of the present invention there is provided a food product comprising the flavour modifying ingredient of the second aspect of the present invention.

In accordance with a fifth aspect of the present invention there is provided the use of a flavour modifying ingredient of the second aspect of the present invention to improve the mouthfeel of a food product.

In accordance with a sixth aspect of the present invention there is provided a method of providing a food product having an improved mouthfeel, the method comprising admixing the flavour modifying ingredient of the second aspect of the present invention to the food product.

In accordance with a seventh aspect of the present invention there is provided the use of a flavour modifying ingredient of the second aspect of the present invention to mask off-notes of a food product.

In accordance with an eighth aspect of the present invention there is provided a method of providing a food product having reduced off-notes, the method comprising admixing the flavour modifying ingredient of the second aspect of the present invention to the food product.

In accordance with a ninth aspect of the present invention there is provided the use of a flavour modifying ingredient of the second aspect of the present invention to improve the sweetness of a food product.

In accordance with a tenth aspect of the present invention there is provided a method of providing a food product having improved sweetness, the method comprising admixing the flavour modifying ingredient of the second aspect of the present invention to the food product.

In certain embodiments of any aspect of the present invention, the food product is a beverage. In certain embodiments, the beverage is a citrus flavoured beverage. In certain embodiments, the beverage is a carbonated soda drink. In certain embodiments, the beverage is a protein drink. In certain embodiments, the beverage is a plant-based protein drink.

In certain embodiments of any aspect of the present invention, the food product further comprises one or more sweeteners. In certain embodiments, the one or more sweeteners are selected from sucrose, fructose, glucose, arabinose, rhamnose, tagatose, allulose, trehalose, isomaltulose, steviol glycosides (e.g. rebaudioside A, rebaudioside B, rebaudioside C, rebaudioside D, rebaudioside M, stevioside), stevia, trilobatin, rebusoside, aspartame, advantame, agarve syrup, acesulfame potassium (AceK), neotame, saccharin, sucralose, high fructose corn syrup, starch syrup, Luo Han Guo extract, mogrosides, neohespiridin, dihydrochalcone, naringin, and sugar alcohols (e.g. sorbitol, xylitol, inositol, mannitol, erythritol).

Certain embodiments of any aspect of the present invention may provide one or more of the following advantages:
production of a natural, clean-label product;
production of a probiotic product;
food product with improved mouthfeel;
food product with reduced off-notes;
food product with improved sweetness;
HIS-containing food products with improved sugar-like sweetness and mouthfeel with reduced off-notes.

The details, examples and preferences provided in relation to any particular one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

The present invention is based, at least in part, on the surprising finding that subjecting pea protein to enzymatic hydrolysis and fermentation according to the processes described herein produces a product that can be used as a flavour modifying ingredient, for example to improve the mouthfeel of a food product, to mask off-notes of a food product, and/or to improve the sweetness of a food product.

In particular, the present invention is based, at least in part, on the surprising finding that the flavour modifying ingredients described herein provide the following organoleptic advantages:
increased sweetness in a composition;
enhanced sweetness in a composition including at least one sweetener;
decrease in the amount of caloric sweetener required to obtain desired sweetness;
improvement of one or more sweetness characteristics to make sweet taste more similar to sugar (sucrose);
weakening of lingering sweetness (e.g., decreasing the length of time the sweet taste remains and/or decreasing the intensity of the sweet taste more rapidly);
weakening of bitter taste and/or liquorice taste and/or metallic taste;
weakening of the sensory perceptions of dryness and/or astringent mouthfeel;
improvement in sweetness impact (e.g., increasing the maximum intensity of the sweet taste and/or decreases the length of time for the sweet taste to be detected) (e.g., decreasing the lingering sweetness).

### Pea Protein

The term pea or peas as used herein refers to the round seeds of the leguminous plant Pisum sativum and its cultivars, having long green pods containing the edible seeds. The term pea or peas as used herein includes other seeds of the family Fabaceae, such as chickpeas. Alternatively, instead of pea seeds, pea sprouts may be used.

The pea protein for use in methods described herein can be in any suitable form, for example in form of pea seeds or sprouts (including whole or ground up seeds and whole or cut sprouts), or as a protein isolate from peas, or any natural material containing protein from pea and optionally additional ingredients.

In certain embodiments, the pea protein is selected from the group consisting of: pea protein liquor, pea protein isolate, pea protein concentrate, pea flour, and mixtures thereof. In certain embodiments, the pea protein is United States Department of Agriculture (USDA) certified organic. It has surprisingly been found that the enzymatic hydrolysis and fermentation methods described herein provide a plant-based, clean-label ingredient capable of modifying the flavour and mouthfeel of food products in an organoleptically desirable manner.

In some embodiments, the pea protein consists of or comprises a pea protein liquor. As used herein, “pea protein liquor” refers to an aqueous pea protein concentrate slurry obtained from the protein extraction or fractionation process. In some embodiments, the pea protein liquor may be used directly in the processes of the disclosure, or may be further diluted or concentrated as appropriate.

### Enzymatic Hydrolysis

Pea protein is subjected to enzymatic hydrolysis, wherein the pea protein is contacted with one or more enzyme(s) under conditions and for a period of time suitable for the enzyme(s) to at least partially break down the pea protein. All enzymes should be food grade.

The enzyme(s) used for enzymatic hydrolysis may, for example, be selected from one or more of carbohydrases and proteolytic enzymes. Where more than one enzyme is used, the enzymes may be more than one class of enzymes and/or more than one enzyme within a single class. In certain embodiments, the enzyme(s) used for enzymatic hydrolysis include at least one or more carbohydrase(s). In certain embodiments, the enzyme(s) used for enzymatic hydrolysis include at least one or more of cellulases, pectinases, and other carbohydrases. In certain embodiments, the enzyme(s) used for enzymatic hydrolysis include at least one or more of cellulases and pectinases. In certain embodiments, one or more amidohydrolase enzyme(s) is used to convert Glutamine to Glutamate.

Proteolytic enzymes catalyse the hydrolysis of proteins and peptides. Proteolytic enzymes include, for example, proteinases, which hydrolyze proteins to form small peptides, and peptidases, which further hydrolyze small peptides to form amino acids. The proteolytic enzyme(s) may, for example, have endopeptidase activity (attack internal peptide bonds) and/or exopeptidase activity (attack peptide bonds at the end of the protein or peptide such as amino- or carboxypeptidases).

Proteolytic enzymes include, for example, protease, peptidase, glutaminase (e.g. L-glutamine-amido-hydrolase (EC 3.5.1.2)), endoprotease, serine endopeptidase, subtilisin peptidase (EC 3.4.21.62), serine protease, threonine protease, cysteine protease, aspartic acid protease, glutamic acid protease, trypsin, chymotrypsin (EC 3.4.21.1), pepsin, papain, and elastase.

Proteolytic enzymes (EC 3.4 and EC 3.5) are classified by an EC number (enzyme commission number), each class comprises various known enzymes of a certain reaction type. EC 3.4 comprises enzymes acting on peptide bonds (peptidases/proteinases) and EC 3.5 comprises enzymes that act on carbon-nitrogen bonds other than peptide bonds.

Examples for EC 3.4 include, for example, the following: aminopeptidase (EC 3.4.11), dipeptidase (3.4.13), dipeptidyl-peptidase (3.4.14), peptidyl-dipeptidase (3.4.15), serine-carboxypeptidase (3.4.16), metallocarboxypeptidase (3.4.17), cysteine-carboxypeptidase (3.4.18), omegapeptidase (3.4.19), serine-endopeptidase (3.4.21), cysteine-endopeptidase (3.4.22), aspartate-endopeptidase (3.4.23), metalloendopeptidase (3.4.24), threonine-endopeptidase (3.4.25).

Examples for EC 3.5 include, without limitation, proteolytic enzymes that cleave in linear amides (3.5.1), for example, without limitation, glutaminase (EC 3.5.1.2) and protein glutaminase (e.g., protein glutaminase®500 from Amano which is not derived from genetically modified microorganisms).

Various proteolytic enzymes, suitable for food-grade applications, are commercially available from suppliers such as Novozymes, Amano, Biocatalysts, Bio-Cat, Valey Research (now subsidiary of DSM), EDC (Enzyme Development Corporation), and others. Some examples include: Neutrase®, Alcalase®, in particular, Alcalase® 2.4 L FG, Protamex®, Flavorzyme® Protana® Prime, Protana® UBoost (available from Novozymes); the Promod® series: e.g. 215P, 278P, 279P, 280P, 192P, and 144P, Flavorpro® 192, Peptidase 433P, and Peptidase 436P (available from Biocatalysts); Protin PC10, Umamizyme®, Peptidase R (or 723), Peptidase A, Peptidase M, Peptidase N, Peptidase P, Peptidase S, Acid protease II, and Thermoase GL30 (available from Amano); Peptidase 600 (available from Bio-Cat); Validase® AFP and Validase® FPII (available from Valey Research); Fungal protease, Exo-protease, Papain, Bromelain, and the Enzeco® series of proteases and peptidases (available from EDC).

In certain embodiments, the enzymes used for enzymatic hydrolysis comprise cellulase, beta-glucanase, and aminopeptidase. In certain embodiments, the enzymes used for enzymatic hydrolysis comprise cellulase, beta-glucanase, aminopeptidase, hemicellulose, and mannanase. In certain embodiments, the enzymes used for enzymatic hydrolysis comprise carbohydrases (such as alpha-amylase and/or glucoamylase) and proteases and/or aminopeptidases (such as protein glutaminase).

Examples of amylase enzymes include but are not limited to (i) alpha-amylase enzyme (Kleistase® SD-80, from Amano Enzyme) which is useful in breaking down amylose and amylopectin to maltose and various dextrins and/or (ii) Glucoamylase (Gluczyme® NLP from Amano Enzyme) which is useful for example, for the breakdown of maltose and various to release glucose and/or Alpha-Amylase enzymes from Novozymes A/S and/or Endo-Amylase enzymes from Novozymes A/S which are useful for example, for the breakdown of amylose and amylopectin to maltose and various dextrins.

The enzymes may be part of an enzyme mix. A number of enzyme preparations such as Celluclast™, Ceramix™, Alcalase™ in particular, Alcalase™ 2.4 L FG, Viscozyme ™, Flavorzyme™, and Umamizyme™, are commercially available and may be used in the enzymatic hydrolysis described herein.

The enzyme(s) may, for example, be obtained or obtainable from a microbial or plant source. Examples include Aspergillus oryzae, Bacillus licheniformis, pineapple, and papaya.

For enzymatic hydrolysis, an enzyme or enzyme preparation containing more than one enzyme and having both proteinase and peptidase activity can be used at a suitable temperature for the one or more enzyme. A suitable temperature will be chosen according to the temperature requirements of the enzymes, for example, Umamizyme™ will tolerate temperatures from about 40° C. to about 60° C., with an optimum at around 55° C. A useful enzyme is a protease enzyme preparation, for example Umamizyme™ (Amano, Elgin, Illinois.). Protease preparations contain two types of enzymes; proteinases, which hydrolyze proteins to form small peptides, and peptidases, which release amino acids from the terminal ends of proteins and peptides. Umamizyme™ originates from Aspergillus oryzae and is rich in endopeptidase and exopeptidase activity.

In certain embodiments, Umamizyme-K is used, which is a food grade proteolytic enzyme preparation developed for protein hydrolysates rich in amino acids produced by Aspergillus oryzae fermentation under current Good Manufacturing Practices. Umamizyme-K has high peptidase activity in contrast to other fungal proteinase preparations. Umamizyme-K has also high proteinase activity, and the proteolytic combination system is possible to hydrolyze various proteins at high level.

Other enzymes include Protana Prime, Protana UBoost and Alcalase 2.4L (all from Novozymes A/S headquartered in Bagsværd, Denmark.) In certain embodiments, the pea protein may, for example, be hydrolyzed with Protana Prime at about 3-4% on protein (enzyme-to-protein ratio). In certain embodiments, the pea protein may, for example, be hydrolyzed with Protana UBoost and/or Alcalase at about 1-2% on protein (enzyme-to-protein ratio).

The amount of enzyme is chosen to ensure sufficient activity and depends on the strength of the enzyme, amount of substrate, and conditions it is used in. The necessary amount of enzyme can be determined by trying out different amounts and testing the effect of the resulting product in a sensory evaluation as described herein.

The ratio of enzyme: substrate may, for example, range from about 0.05:20 to about 3:20, for example from about 0.5:20 to about 3:20, for example around 1:20. The enzymes may, for example, be used in an amount ranging from about 0.1 wt % to about 20 wt % based on the total weight of the pea protein. For example, the enzymes may be used in an amount ranging from about 0.5 wt % to about 15 wt % or from about 1 wt % to about 10 wt % or from about 0.5wt % to about 5wt % or from about 0.5wt % to about 1.5wt % or from about 1wt % to about 1.5wt % based on the total weight of the pea protein.

(Ceremix™, Novozymes, Bagsvaerd, Denmark, has an activity of 300 Beta-Glucanase Units (BGU) per gram of enzyme; Viscozyme™, Novozymes, Bagsvaerd, Denmark, has an activity of 100 Fungal Beta-Glucanase Units FBG per gram of enzyme; Alcalase™, Novozymes, Bagsvaerd, Denmark, has an activity of 2.4 Anson units (AU) per gram of enzyme; Celluclast™, Novozymes, Bagsvaerd, Denmark, has an activity of 700 Endo-Glucanase Units (EGU) per gram of enzyme; Protana Prime™, Novozymes, Bagsvaerd, Denmark, has an activity of 1067 Leucine Amino Peptidase (LAPU) per gram of enzyme; Protana UBoost™, Novozymes, Bagsvaerd, Denmark, has an activity of 100 EGLU-A per gram of enzyme; Flavourzyme™, Novozymes, Bagsvaerd, Denmark, has an activity of 1000 Leucine Aminopeptidase Units (LAPU) per gram of enzyme; Umamizyme™, Amano, Nagoya, Japan, has an activity of 70 U (Units by LGG method, LGG=L-Leucyl-Glycyl-Glycine); Flavorpro 373™, a Glutaminase, Biocatalysts, Cardiff, UK, has an activity of 30 Glutaminase Units (GU)).

Useful amounts of enzyme units per gram starting material are indicated for some type of enzymes below.

Beta-Glucanase Units (BGU) per gram starting material (liquified pea protein slurry) 0.03 to 15 BGU, for example 0.1 to 3 BGU.

Fungal Beta-Glucanase Units FBG per gram starting material, 0.002 to 3 FBG, for example, 0.01 to 1 FBG.

Anson units (AU) per gram starting material, 0.0002 to 0.03 AU, for example 0.0005 to 0.01.

U (Units by LGG method, LGG=L-Leucyl-Glycyl-Glycine) per gram starting material 0.007 to 0.7 U, for example, 0.01 to 0.1 U are used.

Glutaminase Units (GU) per gram starting material, 0.00075 to 0.075 GU, for example, 0.001 to 0.02 GU are used.

Leucine Amino Peptidase units (LAPU) per gram starting material, 0.2 to 40 LAPU, for example, 2 to 30 LAPU are used.

The enzymatic hydrolysis will be performed under conditions suitable for all the enzymes involved. As will be apparent to the skilled person, the temperature and pH should be within a suitable range for hydrolysis to occur to the desired degree. The incubation length will vary accordingly, with shorter incubations when conditions are nearer to the optimum conditions. Necessary ions, if required or beneficial for the chosen enzymes may be present. Subjecting the incubated mixture to agitation, for example by stirring (e.g., at 50 to 500 rpm or 100 to 200 rpm) may improve the hydrolysis.

The enzymatic hydrolysis may, for example, be performed at a temperature less than the temperature at which the enzymes denature. The temperature may, for example, be selected to give a desired reaction rate. The enzymatic hydrolysis may, for example, be performed at a temperature ranging from about 25° C. to about 60° C. For example, the enzymatic hydrolysis may be performed at a temperature ranging from about 30° C. to about 60° C. or from about 35° C. to about 55° C. or from about 40° C. to about 50° C. or from about 50° C. to about 55° C.

In certain embodiments, the enzymatic hydrolysis is performed at a temperature ranging from about 30° C. to about 60° C., for example from about 30° C. to about 40° C. or from about 50° C. to about 55° C.

The enzymatic hydrolysis may, for example, be performed at a pH at which the enzymes do not denature. The pH may, for example, be selected to give a desired reaction rate. The enzymatic hydrolysis may, for example, be performed at a pH ranging from about 4 to about 8, for example from about 5 to about 8, for example from about 6 to about 8, for example from about 6.5 to about 7.5.

The enzymatic hydrolysis may, for example, take place for a period of time ranging from about 1 hour to about 48 hours. For example, the enzymatic hydrolysis may take place for a period of time ranging from about 2 hours to about 48 hours or from about 4 hours to about 36 hours or from about 6 hours to about 24 hours or from about 8 hours to about 16 hours or from about 1-2 hours or up to 5 hours.

In certain embodiments, the enzymatic hydrolysis takes place for a period of time ranging from about 1 hour to about 36 hours or from about 2 hours to about 36 hours or from about 4 hours to about 24 hours or from about 1-2 hours or up to 5 hours.

In certain embodiments, the method comprises hydrolyzing the pea protein with a first proteolytic enzyme for about 10 to about 20 hours at about 40° C. to 60° C., followed by hydrolyzing the pea protein with a second proteolytic enzyme for about 1 to about 5 hours at about 40° C. to 60° C., wherein the first proteolytic enzyme is different than the second proteolytic enzyme.

In certain embodiments, the method comprises adding the first proteolytic enzyme to the aqueous slurry of pea protein or the pea protein base in an amount of about 0.5% to about 1% by weight, based on the total weight of the aqueous slurry or the pea protein base, and subsequently adding the second proteolytic enzyme to the aqueous slurry of pea protein or the pea protein base in an amount of about 0.01% to about 0.1% by weight, based on the total weight of the aqueous slurry or the pea protein base.

### Fermentation

Pea protein hydrolysate is subjected to fermentation, wherein the pea protein hydrolysate is contacted with one or more fermenting microorganism(s) under conditions and for a period of time suitable for the microorganism(s) to at least partially break down/metabolize the pea protein hydrolysate. The pea protein that is the product of the enzymatic hydrolysis may be referred to as hydrolyzed or partly hydrolyzed pea protein.

The fermentation may, for example, use one or more species of microorganism.

The fermentation may, for example, use one or more lactic acid bacteria such as Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus and/or Bifidobacterium animalis lactis, such as, for example, Bifidobacterium animalis lactisalso known as BB-12® from Chr. Hansen or Bifidobacterium animalis lactis also known as Probiotic BifidoBHN019 or DR10 or B019.

In certain embodiments, the fermentation uses Lactobacillus plantarum. For example, the fermentation may use Lactobacillus plantarum, ATCC 14917.

In certain embodiments, the fermentation uses a combination of Lactobacillus plantarum, Lactobacillus rhamnosus, and Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019. In certain embodiments, the fermentation uses Streptococcus thermophilus and optionally one more different lactic acid bacteria.

In certain embodiments, the fermentation uses two or more bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus, and/or Bifidobacterium animalis lactis, such as, for example, Bifidobacterium animalis lactis also known as BB-12® from Chr. Hansen or Bifidobacterium animalis lactis also known as Probiotic BifidoBHN019 or DR10 or B019.

In certain embodiments, the fermentation uses three or more bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus and/or Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019.

In certain embodiments, the fermentation uses four or more lactic acid bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus, and/or Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019.In certain embodiments, the fermentation uses bacteria selected from the group consisting of Lactobacillus paracasei, Lactobacillus delbrueckii subsp. bulgaricus, Lactobacillus acidophilus, Bifidobacterium and Streptococcus thermophilus.

A bacterial culture composition comprising Lactobacillus paracasei, Lactobacillus delbrueckii subsp. bulgaricus, Lactobacillus acidophilus, Bifidobacterium and Streptococcus thermophilus is commercially available from Chr Hansen (“Vega Harmony” product information version 7PI, EU EN 04-26-2021). Bifidobacterium animalis lactis also known as Probiotic BifidoBHN019 or DR10 or B019 which is commercially available from Fonterra Co-Operative Group Ltd (New Zealand).

In certain embodiments, the flavour modifying ingredient is obtained by mixing at least one pea protein in an aqueous solution, wherein the pea protein is selected from the group consisting of green pea protein, chickpea protein and combinations thereof, subjecting the pea protein to enzymatic hydrolysis using one or more proteolytic and/or carbohydrase enzymes to form a pea protein hydrolysate, adding one or more bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus, Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019 and mixtures thereof, to the mixture, and incubating the mixture for a period of time sufficient to ferment at least a portion of the pea protein hydrolysate to form the flavour modifying ingredient.

In certain embodiments, the flavour modifying ingredient is obtained by mixing at least one pea protein in an aqueous solution, wherein the pea protein is selected from the group consisting of green pea protein, chickpea protein and combinations thereof, subjecting the pea protein to enzymatic hydrolysis using one or more proteolytic and/or carbohydrase enzymes to form a pea protein hydrolysate, adding two or more bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium,

In certain embodiments, the flavour modifying ingredient is obtained by mixing at least one pea protein in an aqueous solution, wherein the pea protein is selected from the group consisting of green pea protein, chickpea protein and combinations thereof, subjecting the pea protein to enzymatic hydrolysis using four or more proteolytic and/or carbohydrase enzymes to form a pea protein hydrolysate, adding three or more bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Streptococcus thermophilus Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019and mixtures thereof, to the mixture, and incubating the mixture for a period of time sufficient to ferment at least a portion of the pea protein hydrolysate to form the flavour modifying ingredient.

The fermentation may, for example, use one or more lactic acid bacteria such as L. delbrueckii ssp. bulgaricus, Streptococcus thermophilus and/or Lactobacillus acidophilus. The fermentation may, for example, use a Bifidobacterium.

The fermentation may, for example, use the lactic acid bacteria Lactobacillus rhamnosusand Bifidobacterium animalis lactis (LGG® and BB-12®, respectively, from Chr. Hansen A/S) or Bifidobacterium animalis lactis also known as Probiotic BifidoBHN019 or DR10 or B019 which is commercially available from Fonterra Co-Operative Group Ltd (New Zealand).

The fermentation may, for example, use the lactic acid bacteria Streptococcus thermophilus such as YOFLEX® YF-L01 DA (Streptococcus thermophilus) from Chr. Hansen A/S and/or Lactobacillus bulgaricus (YOFLEX® YF-L02 DA from Chr. Hansen A/S).

The fermentation may, for example, use the lactic acid bacteria LGG® (Lactobacillus rhamnosus) and/or BB-12® (Bifidobacterium animalis lactis) and/or YOFLEX® YF-L01 DA (Streptococcus thermophilus) and/or YOFLEX® YF-L02 DA (Lactobacillus bulgaricus) and/or L. Casei 431 (Lactobacillus paracasei).

The fermentation may, for example, use the lactic acid bacteria Lactobacillus rhamnosus and Lactobacillus bulgaricus.

The fermentation may, for example, use the lactic acid bacteria Bifidobacterium animalis lactis, such as, for example, Bifidobacterium animalis lactis also known as BB-12® from Chr. Hansen or Bifidobacterium animalis lactis also known as Probiotic BifidoBHN019 or DR10 or B019 and Lactobacillus bulgaricus.

The fermentation may, for example, use the lactic acid bacteria Lactobacillus delbrueckii subsp. bulgaricus, Streptococcus thermophilus, Lactobacillus acidophilus, and Bifidobacterium ssp (ABY 421 from Vivolac Cultures Corporation of Indiana, USA.)

The fermentation may, for example use an Aspergillus fungus such as Aspergillus oryzae (also known as Koji) and Aspergillus saitoi. In certain embodiments, the Aspergillus fungus is Aspergillus oryzae.

In certain embodiments, the fermentation uses two or more lactic acid bacteria such as Lactobacillus paracasei, Lactobacillus rhamnosus and/or Bifidobacterium, preferably Bifidobacterium animalis lactis, such as, for example, Bifidobacterium animalis lactis also known as BB-12® from Chr. Hansen or Bifidobacterium animalis lactis also known as Probiotic BifidoBHN019 or DR10 or B019.

In certain embodiments, the fermentation uses three or more lactic acid bacteria such as Lactobacillus paracasei, Lactobacillus rhamnosus and Bifidobacterium, preferably Bifidobacterium animalis lactis, such as, for example, Bifidobacterium animalis lactis also known as BB-12® from Chr. Hansen or Bifidobacterium animalis lactis also known as Probiotic BifidoBHN019 or DR10 or B019.

In certain embodiments, the fermentation uses a combination of the following microbial strains Lactobacillus delbrueckii subsp. bulgaricus, Streptococcus thermophilus, Lactobacillus acidophilus, and Bifidobacterium ssp.

Suitable microbial cultures may include the ABY Series, such as ABY 424 ND and ABY 421 ND, commercially available from Vivolac Cultures Corporation of Indiana, USA.

The microbial culture designated as ABY 421 ND has the following microbial strains: Lactobacillus delbrueckii subsp. bulgaricus, Streptococcus thermophilus, Lactobacillus acidophilus, and Bifidobacterium ssp. The microbial culture designated as ABY 424 ND has the following microbial strains: Lactobacillus delbrueckii subsp. bulgaricus, Streptococcus thermophilus, Lactobacillus acidophilus, and Bifidobacterium ssp. ABY 421 ND and ABY 424 ND were formulated with strains of the same genus species. There are several strains (bacteria) in the same genus and they are classified per their characteristics but there are differences in their plasmid profile that dictate some of their functional characteristics like viscosity production and ability to ferment lactose, phage sensitivity/resistance.

Blends of the two microbial cultures may provide different rates of fermentation depending on the ratio of strains inoculated.

In certain embodiments, the fermentation uses 100% ABY 421 ND. In other embodiments, the fermentation uses 100% and ABY 424 ND.

In certain embodiments, the fermentation uses a combination of ABY 421 ND and ABY 424 ND in about a 50/50 ratio. In certain embodiments, the fermentation uses a combination of ABY 421 ND and ABY 424 ND in about a 70/30 ratio, respectively. In certain embodiments, the fermentation uses a combination of ABY 421 ND and ABY 424 ND in about a 30/70 ratio, respectively.

The fermentation may use an overnight culture of the microorganism(s), or the pea protein hydrolysate obtained from the enzymatic hydrolysis step may be directly inoculated with a microorganism clone, and the fermentation performed for a slightly longer time accordingly.

The overnight culture (sometimes referred to as seed ferment) may be prepared by methods well-known in the art. It may be grown overnight, for example 12 hours, at the appropriate temperature for that microorganism. Approximately 37° C. is an appropriate temperature for many microorganisms, including Lactobacillus paracasei, Lactobacillus casei, Lactobacillus rhamnosus, Lactobacillus bulgaricus, Lactobacillus delbrueckiisubsp. bulgaricus, Lactobacillus acidophilus, Lactobacillus plantarum, Lactiplantibacillus plantarum, Lactobacillus brevis, Lactobacillus helveticus, Bifidobacterium, Bifidobacterium animalis lactis such as, for example, Bifidobacterium animalis lactis also known as BB-12® from Chr. Hansen or Bifidobacterium animalis lactis also known as Probiotic BifidoBHN019 or DR10 or B019, Streptococcus thermophilus and/or Aspergillus oryzae. Any suitable medium may be used, for example, MRS broth (Difco, United States of America).

The microorganism(s) may, for example, be administered on a carrier. For example, the microorganism(s) (e.g., Aspergillus oryzae) may be coated onto rice grains. For example, the microorganism(s) may be grown on rice grains and offered by suppliers in this form (e.g., obtainable from Rhapsody Natural Foods, Cabot VT 05647). This may, for example, induce the production of certain endogenous enzymes and/or pathways, thereby providing the microorganism(s) with desirable characteristics.

The amount of microorganism is chosen to ensure sufficient activity and depends on the activity of the microorganism, amount of substrate, and conditions it is used in. The necessary amount of microorganism can be determined by trying out different amounts and testing the effect of the resulting product in a sensory evaluation as described herein.

The amount of microorganism may, for example, range from about 0.1% to about 1% based on the total weight of the pea protein. For example, the amount of microorganism used may range from about 0.1% to about 0.5% or from about 0.3% to about 0.7% based on the total weight of the pea protein.

The fermentation will be performed under conditions suitable for all the microorganisms involved. As will be apparent to the skilled person, the temperature and pH should be within a suitable range for fermentation to occur to the desired degree. The incubation length will vary accordingly, with shorter incubations when conditions are nearer to the optimum conditions. Necessary nutrients if required or beneficial for the chosen microorganisms may be present. Subjecting the incubated mixture to agitation, for example by stirring (e.g. at 50 to 500 rpm or 100 to 200 rpm) may improve the fermentation. Some microorganisms such as lactic acid bacteria may grow faster under anaerobic conditions so it may be favourable to minimize stirring. In certain embodiments, aerotolerance may be manganese-dependent.

The fermentation may, for example, be performed at a temperature less than the temperature at which the microorganisms are killed and/or reduced in numbers. The temperature may, for example, be selected to give a desired reaction rate. The fermentation may, for example, be performed at a temperature ranging from about 20° C. to about 45° C. For example, the fermentation may be performed at a temperature ranging from about 25° C. to about 40° C. or from about 30° C. to about 40° ° C. or from about 34° C. to about 40° C. or from about 30° C. to about 37° C. or from about 30° C. to about 35° C.

Useful temperature ranges for Lactobacilli, in particular Lactobacillus plantarum Lactiplantibacillus plantarum, include, for example, from about 20° C. to about 40° C., or from about 30° C. to about 40° C., or from about 35° C. to about 40° C., with an optimum of about 36° C. to about 38° C.

Useful temperature ranges for Bifidobacteria or lactic acid bacteria, in particular, L. delbrueckii ssp. bulgaricus, Streptococcus thermophilus and/or Lactobacillus acidophilusinclude, for example, from about 20° C. to about 40° C., or from about 30° C. to about 40° C., or from about 35° C. to about 40° C., with an optimum of about 36° C. to about 38° C. or from about 30° C. to about 35° C. or from about 30° C. to about 37° C.

The fermentation may, for example, be performed at a pH less than the temperature at which the microorganisms denature. The pH, for example, be selected to give a desired reaction rate. The fermentation may, for example, be performed at a pH ranging from about 5 to about 8, for example from about 5 to about 7 or from about 6 to about 8 or from about 6.5 to about 7.5.

The fermentation may take place for a period of time until the desired product is formed. Fermentation may, for example, take place until the fermentation medium reaches a pH of about 5.5 or lower, for example a pH of about 4.5 to about 5.5.

The fermentation may, for example, take place for a period of time ranging from about 1 day to about 10 days. For example, the fermentation may take place for a period of time ranging from about 2 days to about 9 days or from about 3 days to about 8 days or from about 4 days to about 7 days.

In certain embodiments, the fermentation may take place for a period of time ranging from about 1 day to about 8 days or from about 2 days to about 6 days or from about 2 days to about 5 days or from about 2 days to about 4 days or from about 1 to about 2 days.

### Further Processing Steps

The product of the enzymatic hydrolysis and fermentation may, for example, be used directly as a flavour modifying ingredient. However, the methods may, for example, comprise one or more additional steps.

The pea protein that is subjected to the enzymatic hydrolysis and fermentation described herein may, for example, be an aqueous slurry of pea protein. The pea protein that is subjected to the enzymatic hydrolysis and fermentation described herein may also, for example, be a pea protein base. In certain embodiments, pea protein is used as a base material in combination with other ingredients, for example, solvents, binders, diluents, disintegrating agents, lubricants, colouring agents, preservatives, antioxidants, emulsifiers, stabilisers, anti-caking agents, gums, starches, dextrins, vitamins, minerals, functional ingredients and the like, Thus, in certain embodiments, the method may comprise combining the pea protein with water or other ingredients prior to the enzymatic hydrolysis and fermentation. The aqueous slurry of pea protein or the pea protein base may, for example, comprise at least about 5 wt % pea protein, for example at least about 10 wt % pea protein, for example at least about 15 wt % pea protein. The aqueous slurry of pea protein or the pea protein base may, for example, comprise up to about 90 wt % pea protein or up to about 50 wt % pea protein or up to about 30 wt % pea protein.

In certain embodiments, the aqueous slurry of pea protein or the pea protein base is sterilized prior to forming the pea protein hydrolysate. For example, the aqueous slurry of pea protein or the pea protein base may be sterilized by heating the aqueous slurry of pea protein or the pea protein base to about 120-125° C. for about 30 minutes, and subsequently allowing the aqueous slurry or the pea protein base to cool down to about 50° C.

In certain embodiments, the pea protein is present in an amount of about 5% to about 60% by weight, based on the total weight of the aqueous slurry or the pea protein base. In certain embodiments, the pea protein is present in an amount of about 5% to about 50% by weight, based on the total weight of the aqueous slurry or the pea protein base. In certain embodiments, the pea protein is present in an amount of about 5% to about 40% by weight, based on the total weight of the aqueous slurry or the pea protein base. In certain embodiments, the pea protein is present in an amount of about 10% to about 30% by weight, based on the total weight of the aqueous slurry or the pea protein base.

The enzymatic hydrolysis and fermentation should be performed in a sterilized container. Thus, the container may be sterilized prior to adding the pea protein.

The pea protein (e.g. aqueous slurry of pea protein or the pea protein base) may, for example, be heated prior to the enzymatic hydrolysis and/or fermentation. For example, the pea protein may be heated to a temperature equal to or greater than about 50° C., for example heated to a temperature in the range of 50° C. to about 55° C., or heated to a temperature equal to or greater than about 75° C., for example equal to or greater than about 100° C. or equal to or greater than about 110° C., prior to the enzymatic hydrolysis and/or fermentation. For example, the pea protein may be heated to a temperature equal to or less than about 140° C., for example equal to or less than about 130° C. prior to the enzymatic hydrolysis and/or fermentation. For example, the pea protein may be heated to a temperature of about 121° C. prior to enzymatic hydrolysis and/or fermentation. This may be to inactivate and/or kill any microbial contaminants and/or to hydrate and/or pre-heat the pea protein (e.g. aqueous slurry of pea protein or the pea protein base) prior to enzymatic hydrolysis and/or fermentation. The pea protein is then maintained at a suitable temperature and/or cooled to a suitable temperature for the enzymatic hydrolysis and/or fermentation before the enzyme(s) and/or microorganism(s) are added.

The enzyme(s) and/or microorganism(s) may, for example, be deactivated prior to incorporation in a flavour composition or food product. This may, for example, take place by heating, for example to a temperature ranging from about 60° C. to about 121° C., for example about 100° C., for a period of time sufficiently long to deactivate the enzymes and/or microorganism(s). For example, any pasteurization or sterilization methods which are well-known in the art, may be used. For example, the enzymes and/or microorganisms may be deactivated by heating to about 70° C., about 90° C. or about 100° C. or higher for 30 minutes or 45 minutes or 60 minutes. When heating above about 100° C., for example about 121° C., for about 30 minutes, heating may be performed under pressure, for example about 12 to about 15 psi.

The product of the enzymatic hydrolysis and fermentation (the flavour modifying ingredient) may, for example, be filtered or centrifuged to remove large particles. The product of the enzymatic hydrolysis and fermentation (the flavour modifying ingredient) may, for example, be concentrated, for example by evaporation including boiling at, for example, up to about 100° C. The product of the enzymatic hydrolysis and fermentation (the flavour modifying ingredient) may, for example, be spray-dried by methods known in the art, for example using carriers such as and maltodextrin and/or anti-caking agents.

Filtering may be performed by any suitable filtering method, such methods are well known in the art, for example, by passing through a felt filter bag in a filter centrifuge. The filtered culture (supernatant containing the remaining smaller solids, minus the biomass that includes larger undigested proteins) can be concentrated, for example concentrated 2x by evaporation/boiling at 100° C. The resulting concentrate's solid content can be determined using a moisture analyser and can be spray-dried, for example, onto a suitable carrier. Many carriers are well known in the art, for example, without limitation, a potato maltodextrin carrier (for example, a ratio of about 1:1 solids of the 2× concentrate to carrier may be suitable). Optionally an anti-caking agent may be added, such agents are well known. A suitable anti-caking agent is, for example, tricalciumphosphate (TPC); about 0.5% (wt/wt) based on total weight of the 2× concentrate would be a suitable amount.

The flavour modifying ingredient may, for example, be used in filtered and/or concentrated form.

The product of the enzymatic hydrolysis and fermentation (the flavour modifying ingredient) may, for example, be combined with one or more stabilizing agents such as propylene glycol.

### Products

The flavour modifying ingredient made by the processes described herein may be used directly in flavour compositions and/or food compositions or may undergo further processing as described above. For example, the flavour modifying ingredient may be in filtered and/or concentrated and/or paste and/or spray-dried form. The flavour modifying ingredient may, for example, be in combination with a stabilizer such as propylene glycol, or may be in combination with one or more carriers and/or anti-caking agents used in the spray-drying process. The flavour modifying ingredient may, for example, be considered to be a natural, clean-label product for food labelling and/or food regulation reasons. By way of example, the flavour modifying ingredient may, for example, be considered to be a Ready to Eat (RTE) or Ready to Drink (RTD) product and a Ready to Eat (RTE) or Ready to Drink (RTD) product.

The final form of the flavour modifying ingredient may be chosen according to methods well known in the art and will depend on the particular food application. For liquid foods, for example beverages, the flavour modifying ingredient can be used without further processing in its liquid form. For dry applications such as crackers, the spray-dried concentrated flavour modifying ingredient can be used.

The flavour modifying ingredient may be directly added to food products, or may be provided as part of a flavour composition for flavouring or seasoning food products.

Flavour compositions contain the flavour modifying ingredient and optionally one or more food grade excipient. Suitable excipients for flavour compositions are well known in the art and include, for example, without limitation, solvents (including water, alcohol, ethanol, oils, fats, vegetable oil, and miglyol), binders, diluents, disintegrating agents, lubricants, flavouring agents, colouring agents, preservatives, antioxidants, emulsifiers, stabilisers, flavour-enhancers, sweetening agents, anti-caking agents, and the like. Examples of such carriers or diluents for flavours may be found e.g. in “Perfume and Flavour Materials of Natural Origin”, S. Arctander, Ed., Elizabeth, N.J., 1960; in “Perfume and Flavor Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998 , and “CTFA Cosmetic Ingredient Handbook”, J.M. Nikitakis (ed.), 1st ed., The Cosmetic, Toiletry and Fragrance Association, Inc., Washington, 1988.

The flavour composition may contain additional flavour ingredients including flavour compounds, flavours from natural sources including botanical sources and including ingredients made by fermentation.

The flavour composition may have any suitable form, for example liquid or solid, wet or dried, or in encapsulated form bound to or coated onto carriers/particles or as a powder.

In certain embodiments, the flavour composition may, for example, comprise from about 0.001% to about 50% (wt/wt) of the flavour modifying ingredient, based on the total weight of the flavour composition. In certain embodiments, the flavour composition comprises from about 0.1% to about 40% (wt/wt) of the flavour modifying ingredient, based on the total weight of the flavour composition. In certain embodiments, the flavour composition comprises from about 1% to about 30% (wt/wt) of the flavour modifying ingredient, based on the total weight of the flavour composition. In certain embodiments, the flavour composition comprises from about 1% to about 20% (wt/wt) of the flavour modifying ingredient, based on the total weight of the flavour composition. In certain embodiments, the flavour composition comprises from about 2% to about 20% (wt/wt) of the flavour modifying ingredient, based on the total weight of the flavour composition. In certain embodiments, the flavour composition comprises from about 3% to about 15% (wt/wt) of the flavour modifying ingredient, based on the total weight of the flavour composition.

The term “food product” is used in a broad meaning to include any product placed into the oral cavity but not necessarily ingested, including, for example, food, beverages, nutraceuticals and dental care products including mouth wash.

Food products include cereal products, rice products, pasta products, ravioli, tapioca products, sago products, baker's products, biscuit products, pastry products, bread products, confectionery products, dessert products, gums, chewing gums, chocolates, ices, honey products, treacle products, yeast products, salt and spice products, savoury food products, mustard products, vinegar products, sauces (condiments), processed foods, cooked fruits and vegetable products, meat and meat products, meat analogues/substitutes/alternatives, jellies, jams, fruit sauces, egg products, dairy products (including milk), cheese products, butter and butter alternative products, milk alternative products, soy products (e.g. soy “milk”), edible oils and fat products, medicaments, beverages, juices, fruit juices, vegetable juices, food extracts, plant extracts, meat extracts, condiments, nutraceuticals, gelatins, tablets, lozenges, drops, emulsions, elixirs, syrups, and combinations thereof.

Exemplary savoury products include, but are not limited to, salty snacks (potato chips, crisps, nuts, tortilla-tostada, pretzels, cheese snacks, corn snacks, potato-snacks), ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, mayonnaise, vegan mayonnaise and pasta sauces.

Of particular interest are, for example, dairy products such as milk (e.g. cow's milk, goat's milk, sheep's milk, camel's milk), cream, butter, cheese, yoghurt, ice cream, and custard. The dairy products may, for example, be sweetened or unsweetened. The dairy products (e.g. milk) may, for example, be full-fat, low-fat, or non-fat.

Dairy alternative products are also of particular interest. Dairy alternative products are plant-based products that do not encompass true dairy products that have been obtained from an animal. For example, dairy alternative products include alternative “milk”, “cream”, and “yoghurt” products which may, for example, be derived from soy, pea, almond, rice, pea, coconut, and nuts (e.g. cashew). The dairy alternative products may, for example, be sweetened or unsweetened.

Of further particular interest are, for example, beverages including beverage mixes and concentrates, including, for example, alcoholic and non-alcoholic ready to drink and dry powdered beverages, carbonated and non-carbonated beverages, e.g., sodas, fruit or vegetable juices, alcoholic and non-alcoholic beverages. The beverages may, for example, be sweetened or unsweetened.

Processed foods include margarine, peanut butter, soup (clear, canned, cream, instant, UHT), gravy, canned juices, canned vegetable juice, canned tomato juice, canned fruit juice, canned juice drinks, canned vegetables, pasta sauces, frozen entrees, frozen dinners, frozen hand-held entrees, dry packaged dinners (macaroni & cheese, dry dinners-add meat, dry salad/side dish mixes, dry dinners-with meat). Soups may be in different forms including condensed wet, ready-to-serve, ramen, dry, and bouillon, processed and pre-prepared low-sodium foods.

Of particular interest are, for example, beverages including beverage mixes and concentrates, including, for example, alcoholic and non-alcoholic ready to drink and dry powdered beverages, carbonated and non-carbonated beverages, e.g., sodas, fruit or vegetable juices, alcoholic and non-alcoholic beverages. The beverages may, for example, be sweetened or unsweetened. Of further particular interest are reduced-calorie citrus flavoured beverages.

In certain embodiments, the food product may, for example, comprise from about 0.1 ppm to about 200 ppm of the flavour modifying ingredient, based on the total weight of the food product. In certain embodiments, the food product may, for example, comprise from about 1 ppm to about 100 ppm of the flavour modifying ingredient, based on the total weight of the food product. In certain embodiments, the food product may, for example, comprise from about 1 ppm to about 50 ppm of the flavour modifying ingredient, based on the total weight of the food product. In certain embodiments, the food product may, for example, comprise from about 1 ppm to about 20 ppm of the flavour modifying ingredient, based on the total weight of the food product. In certain embodiments, the food product may, for example, comprise less than 5 ppm of the flavour modifying ingredient, based on the total weight of the food product. In certain embodiments, the food product may, for example, comprise about 1 ppm of the flavour modifying ingredient, based on the total weight of the food product, or about 1 to about 2 ppm of the flavour modifying ingredient, based on the total weight of the food product, or about 0.1 to about 5 ppm of the flavour modifying ingredient, based on the total weight of the food product, or about 0.1 to about 2 ppm of the flavour modifying ingredient, based on the total weight of the food product.

The flavour modifying ingredient may be used in unconcentrated or concentrated form or the concentrate may be formulated into a paste or powder by methods known in the art. In this case the amount to be used has to be adjusted accordingly. Flavour compositions such as spices are often more concentrated, for example a 10× concentrate, and the concentration will be adjusted higher accordingly (250 ppm to 3000 ppm).

The appropriate concentration of the flavour modifying ingredient can be easily tested by an organoleptic titration. This technique is well known in the field of sensory analysis.

The flavour compositions and food products may, for example, comprise one or more sweeteners. Examples of sweeteners that may be used in the sweetened compositions are disclosed, for example, in WO 2016/038617, the contents of which are incorporated herein by reference.

The one or more sweeteners may, for example, be selected from sucrose, fructose, glucose, xylose, arabinose, rhamnose, tagatose, allulose, trehalose, isomaltulose, steviol glycosides (e.g. rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, naringin dihydrochalcone, stevioside), mogrosides (e.g. grosvenorine II, grosvenorine I, 11-O-mogroside II (I), 11-O-mogroside II (II), 11-O-mogroside II (III), mogroside II (I), mogroside II (II), mogroside II (III), 11-dehydroxy-mogroside III, 11-O-mogroside III, mogroside III (I), mogroside III (II), mogroside IIIe, mogroside IIIx, mogroside IV (I) (siamenoside), mogroside IV (II), mogroside IV (III), mogroside IV (IV), deoxymogroside V (I), deoxymogroside V (II), 11-O-mogroside V (I), mogroside V isomer, mogroside V, iso-mogroside V, 7-O-mogroside V, 11-O-mogroside VI, mogroside VI (I), mogroside VI (II), mogroside VI (III) (neomogroside) and mogroside VI (IV)), stevia, trilobatin, rebusoside, aspartame, advantame, agarve syrup, acesulfame potassium (AceK), high fructose corn syrup, neotame, saccharin, sucralose, high fructose corn syrup, starch syrup, Luo Han Guo extract, neohespiridin, dihydrochalcone, naringin, sugar alcohols (e.g. sorbitol, xylitol, inositol, mannitol, erythritol), cellobiose, psicose, and cyclamate.

The one or more sweeteners may, for example, be selected from high-intensity sweeteners and/or low-intensity sweeteners.

The term “high-intensity sweetener” refers to compounds having a sweetness that is at least 100 times the sweetness of sucrose. In certain embodiments, the high-intensity sweetener has a sweetness that is at least about 120 or at least about 140 or at least about 150 or at least about 160 or at least about 180 or at least about 200 or at least about 220 or at least about 240 or at least about 250 or at least about 260 or at least about 280 or at least about 300 or at least about 320 or at least about 340 or at least about 350 or at least about 360 or at least about 380 or at least about 400 or at least about 420 or at least about 440 or at least about 450 times the sweetness of sucrose. The high-intensity sweetener may, for example, have a sweetness that is up to 1000 times the sweetness of sucrose.

The one or more high-intensity sweetener(s) may, for example, be one or more steviol glycosides and/or one or more mogrosides. For example, the one or more high-intensity sweetener may be a mixture of steviol glycosides and mogrosides. For example, the one or more high-intensity sweeteners may be one or more steviol glycosides. For example, the one or more high-intensity sweetener(s) may be one or more mogrosides.

Examples of steviol glycosides include, for example, stevioside (CAS: 57817-89-7), rebaudioside A (CAS: 58543-16-1), rebaudioside B (CAS: 58543-17-2), rebaudioside C (CAS: 63550-99-2), rebaudioside D (CAS: 63279-13-0), rebaudioside E (CAS: 63279-14-1), rebaudioside F (CAS: 438045-89-7), rebaudioside G (CAS: 127345-21-5), rebaudioside H, rebaudioside I (CAS: 1220616-34-1), rebaudioside J, rebaudioside K, rebaudioside L, rebaudioside M (CAS: 1220616-44-3), rebaudioside N (CAS: 1220616-46-5), rebaudioside O (CAS: 1220616-48-7), dulcoside A (CAS: 64432-06-0), dulcoside B (CAS: 63550-99-2), rubusoside (CAS: 64849-39-4) and Naringin Dihydrochalcone (CAS: 18916-17-1).

In certain embodiments, the high-intensity sweetener may be one or more of mogroside IV, siamenoside, neomogroside and mogroside V (including all isomers thereof). For example, the high-intensity sweetener may be a mixture of mogroside IV, siamenoside and mogroside V (including all isomers thereof).

In certain embodiments, the flavour modifying ingredient is added to sweetened food products. In certain embodiments, the food product is sweetened with at least one high-intensity sweetener and/or at least one low-intensity sweetener.

One or more sweeteners added to flavour compositions or food products may be natural, artificial, and/or high-intensity and may function to make the products taste more appealing. Natural, high-intensity sweeteners, such as stevia or stevia derivatives, may be used as a low-calorie alternative to or in combination with other sweeteners, such as other natural, high-intensity sweeteners, sugar (e.g., liquid sugar, crystallized sugar, honey, agave, cane juice, etc.), and/or artificial sweeteners (e.g., sucralose, aspartame, saccharine, etc.). In some embodiments, an amount of sugar to be combined with the natural, high-intensity sweetener may be selected to yield a selected sweetness level and selected number of calories, while minimizing metallic or bitter flavours that may be associated with the natural, high-intensity sweetener alone.

In certain embodiments, a sugar blend is added to flavour compositions or food products. A sugar blend may be used in low or mid calorie applications, such as beverages. In certain embodiments, the sugar blend comprises at least one high-intensity sweetener and at least one low-intensity sweetener. Exemplary low-intensity sweeteners include sucrose, dextrose, fructose, or combinations thereof. Exemplary high-intensity sweeteners include Rebaudioside A, acesulfame potassium, sucralose. A suitable sugar blend may, for example, comprise acesulfame potassium, sucralose and sucrose. Another suitable sugar blend may, for example, comprise Rebaudioside A and sucrose.

### Uses

The flavour modifying ingredient obtained by and/or obtainable by the methods described herein may, for example, be added to food products (e.g. as part of a flavour composition) to modify the flavour or mouthfeel of the food product.

The flavour modifying ingredient obtained by and/or obtainable by the methods described herein may, for example, be used to improve the mouthfeel of a food product and/or to mask off-notes of a food product and/or to improve the sweetness of a food product and/or to act as a prebiotic in a food product and/or to act as a probiotic in a food product. Thus, there is also provided herein a method of providing a food product having improved mouthfeel and/or reduced off-notes and/or improved sweetness and/or use as a prebiotic and/or use as a probiotic, the method comprising admixing the flavour modifying ingredient obtained by and/or obtainable by the methods described herein with the food product.

In general terms, “mouthfeel” refers to the complexity of perceptions experienced in the mouth as influenced by the aroma, taste, and texture qualities of food and beverage products. From a technical perspective, however, mouthfeel sensations are specifically associated with physical (e.g. tactile, temperature) and/or chemical (e.g. pain) characteristics perceived in the mouth via the trigeminal nerve. Accordingly, they are a consequence of oral-tactile stimulations and involve mechanical, pain and temperature receptors located in the oral mucosa, lips, tongue, cheeks, palate and throat.

Mouthfeel perceptions include, for example, one or more of texture—astringent, burning, cold, tingling, thick, biting, fatty, oily, slimy, foamy, melting, sandy, chalky, watery, acidic, lingering, metallic, body, body sweet, carbonation, cooling, warming, hot, juicy, mouth drying, numbing, pungent, salivating, spongy, sticky, fullness, cohesiveness, density, fracturability, graininess, grittiness, gumminess, hardness, heaviness, moisture absorption, moisture release, mouthwatering, mouthcoating, roughness, slipperiness, smoothness, uniformity, uniformity of bite, uniformity of chew, viscosity, fast-diffusion, full body, salivation and retention.

As stated previously, the perceived mouthfeel of a food or beverage can be broadly influenced by the presence of aroma and taste attributes in addition to textural properties. Thus a number of other attributes may affect the experienced overall mouthfeel sensation of a product including, for example, one or more of taste or aroma—for example sweet, salty, umami, sour, bitter, creamy sour, acidic, acidic dairy, green onion, toasted onion and parsley.

By “improvement of mouthfeel” it is meant that any one or more of desired mouthfeel perceptions is/are enhanced and/or that any one or more undesirable mouthfeel perceptions is/are reduced. In particular, one or more of the following perceptions may be enhanced by the product and methods described herein: sweet, smoothness, syrupy, sugar-like.

By “masking of off-notes” it is meant that the intensity and/or length of perception of undesirable attributes in a food product is reduced, as analysed by trained panellists when comparing food comprising an ingredient with off-note masking to food without an added off-note masking ingredient.

By “improvement in sweetness” it is meant the effect of the flavour modifying ingredient on the sweetness characteristics of a food which are found to be more favourable as analysed by trained panellists when comparing food comprising an ingredient with sweetness improving effect to food without an added sweetness improving ingredient.

The improvement in sweetness may, for example, provide sweetness characteristics that are more similar to the sweetness characteristics of sucrose (sugar).

The sweetness characteristics may refer to the flavour profile (taste profile), which refers to the intensity of the flavour and perceptual attributes of a given compound. Exemplary flavour attributes of sweetness are sweetness intensity, bitterness, black liquorice, etc.

The sweetness characteristics may refer to the temporal profile, which refers to the changes in perception of sweetness over time. Every sweetener exhibits a characteristic appearance time (AT) and extinction time (ET). Most high-intensity sweeteners display prolonged ET (lingering). Generally, the detected sucrose equivalence spikes to a maximal response level, then tapers off over time. The longer the taper, the greater the detected sweetness linger of a compound.

The improvement in sweetness may, for example, be particularly obtained when the flavour modifying ingredient is used in sweetened food products. The improvement of sweetness may, for example, be particularly obtained in beverages, for example sweetened beverages.

In certain embodiments, the flavour modifying ingredient may be used to weaken the lingering sweet taste of the food product (e.g. sweetened food product). In other words, the flavour modifying ingredient may be used to decrease the extinction time (ET) of the food product (e.g. sweetened food product). This relates to the undesirable lingering of the sweetness taste in the mouth after the food product is initially ingested or expectorated. The lingering sweet taste may, for example, refer to the length of time that the sweetness taste remains after it is initially detected, how rapidly the intensity of the sweetness taste decreases or fades after it is initially detected and the intensity of the sweetness taste after it is initially detected. The flavour modifying ingredient may, for example, decrease the length of time that the sweetness taste remains after it is initially detected and/or increase the speed at which the sweetness taste decreases after it is initially detected and/or decrease the intensity of the sweetness taste after it is initially detected.

In certain embodiments, the flavour modifying ingredient may be used to weaken the bitter taste and/or astringent taste and/or metallic taste and/or liquorice taste of the food product (e.g. sweetened food product).

In certain embodiments, the flavour modifying ingredient may be used to strengthen the sweetness impact of the food product (e.g. sweetened food product). The sweetness impact relates to the length of time it takes before the sweetness is initially detected and the intensity at which the sweetness is initially detected. The flavour modifying ingredient may, for example, decrease the amount of time before the sweetness is initially detected and/or increase the intensity at which the sweetness is initially detected.

The degree of sweetness and other sweetness characteristics described herein may be evaluated by a tasting panel of trained experts, for example as described in the examples below.

By “prebiotic” it is meant the effect of the flavour modifying ingredient to improve the effect of gut flora, for example by increasing the activity of the gut flora and/or by increasing the population of the gut flora. By “probiotic” it is meant live bacteria, for example the microbial strains or blends of strains described herein, that ferment substances, for example pea protein.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. The term “comprising” also means “including” as well as “consisting” e.g. a composition “comprising” X may consist exclusively of X or may include something additional e.g. X+Y. It must be noted also that, as used in this specification and the appended claims, the singular forms “a”, “an” and “the” include plural referents unless the content clearly dictates otherwise. By way of example, a reference to “a gene” or “an enzyme” is a reference to “one or more genes” or “one or more enzymes”.

In this document and in its claims, the verb “to comprise” and its conjugations is used in its non-limiting sense to mean that items following the word are included, but items not specifically mentioned are not excluded. In addition, the verb “to consist” may be replaced by “to consist essentially of” meaning that a composition as described herein may comprise additional component(s) than the ones specifically identified, said additional component(s) not altering the unique characteristics of the invention. In addition, the verb “to consist” may be replaced by “to consist essentially of” meaning that a method or use as described herein may comprise additional step(s) than the ones specifically identified, said additional step(s) not altering the unique characteristic of the invention. In addition, the verb “to consist” may be replaced by “to consist essentially of” meaning that a nucleotide or amino acid sequence as described herein may comprise additional nucleotides or amino acids than the ones specifically identified, said additional nucleotides or amino acids not altering the unique characteristics of the invention.

As used herein, with “at least” a particular value means that particular value or more. For example, “at least 2” is understood to be the same as “2 or more” i.e., 2, 3, 4, 5, 6, 7, 8, 9, 10, 11, 12, 13, 14, 15, . . . , etc.

The word “about” or “approximately” when used in association with a numerical value (e.g. about 10) preferably means that the value may be the given value (of 10) more or less 1% of the value.

As used herein, the term “and/or” is understood to mean that all members of a group connected by the term “and/or” are represented both cumulatively with respect to each other in any combination, and alternatively with respect to each other. Exemplarily, for the expression “A, B and/or C”, the following disclosure is to be understood thereunder: i) (A or B or C), or ii) (A and B), or iii) (A and C), or iv) (B and C), or v) (A and B and C), or vi) (A and B or C), or vii) (A or B and C), or viii) (A and C or B).

Various embodiments are described herein. Each embodiment as identified herein may be combined together unless otherwise indicated. It is to be understood that this disclosure is not limited to the particular methodology, protocols and reagents described herein as these may vary. It is also to be understood that the terminology used herein is for the purpose of describing particular embodiments only, and is not intended to limit the scope of the present disclosure which will be limited only by the appended claims. Unless defined otherwise, all technical and scientific terms used herein have the same meanings as commonly understood by the person skilled in the art. In accordance with the present disclosure there may be conventional molecular biology, microbiology, and recombinant DNA techniques employed which are within the skill of the art.

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. Preferably, the terms used herein are defined as described in “A multilingual glossary of biotechnological terms: (IUPAC Recommendations)”, Leuenberger, H.G.W, Nagel, B. and Kolbl, H. eds. (1995), Helvetica Chimica Acta, CH-4010 Basel, Switzerland).

Several documents are cited throughout the text of this specification. Each of the documents cited herein (including all patents, patent applications, scientific publications, manufacturer's specifications, instructions, GenBank Accession Number sequence submissions etc.), whether supra or infra, is hereby incorporated by reference in its entirety.

The examples described herein are illustrative of the present disclosure and are not intended to be limitations thereon. Different embodiments of the present disclosure have been described according to the present disclosure. Many modifications and variations may be made to the techniques described and illustrated herein without departing from the spirit and scope of the disclosure. Accordingly, it should be understood that the examples are illustrative only and are not limiting upon the scope of the disclosure.

### Aspects

1. A method for making a flavour modifying ingredient, the method comprising the steps of:
   i. forming an aqueous slurry of a pea protein or a pea protein base;
   ii. subjecting the pea protein to enzymatic hydrolysis using one or more proteolytic enzymes to form a pea protein hydrolysate;
   iii. subjecting the pea protein hydrolysate to fermentation using one or more lactic acid bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Bifidobacterium animalis lactis and/or Streptococcus thermophilus.
2. The method of aspect 1, wherein the pea protein is selected from the group consisting of: pea protein liquor, pea protein isolate, pea protein concentrate, pea flour, and mixtures thereof.
3. The method of aspect 1 or 2, wherein the pea protein is present in an amount of about 10% to about 30% by weight, based on the total weight of the aqueous slurry or the pea protein base.
4. The method of any preceding aspect further comprising sterilizing the aqueous slurry or the pea protein base prior to forming the pea protein hydrolysate.
5. The method of any preceding aspect further comprising sterilizing the aqueous slurry or the pea protein base at about 120-125° C. for about 30 minutes, and subsequently allowing the aqueous slurry or the pea protein base to cool down to about 50° ° C.
6. The method of any preceding aspect, wherein the one or more proteolytic enzymes are selected from the group consisting of proteinase, peptidase, glutaminase, and mixtures thereof.
7. The method of any preceding aspect, wherein the one or more proteolytic enzymes comprise both endopeptidase and exopeptidase activity.
8. The method of any preceding aspect comprising using two or more proteolytic enzymes.
9. The method of any preceding aspect, comprising hydrolyzing the pea protein with a first proteolytic enzyme for about 10 to about 20 hours at about 40° C. to 60° C., followed by hydrolyzing the pea protein with a second proteolytic enzyme for about 1 to about 5 hours at about 40° C. to 60° C., wherein the first proteolytic enzyme is different than the second proteolytic enzyme.
10. The method of aspect 9 comprising adding the first proteolytic enzyme to the aqueous slurry or the pea protein base in an amount of about 0.5% to about 1% by weight, based on the total weight of the aqueous slurry or the pea protein base, and subsequently adding the second proteolytic enzyme to the aqueous slurry or the pea protein base in an amount of about 0.01% to about 0.1% by weight, based on the total weight of the aqueous slurry or the pea protein base.
11. The method of any preceding aspect, wherein the lactic acid bacteria is selected from the group consisting of: Lactobacillus plantarum, Lactobacillus casei, Lactobacillus paracasei, Lactobacillus brevis, Lactobacillus helveticus, L. delbrueckii ssp. bulgaricus, Streptococcus thermophilus, Lactobacillus acidophilus, Bifidobacterium, Lactobacillus rhamnosus and combinations thereof, preferably a combination comprising Bifidobacterium, Lactobacillus acidophilus, L. delbrueckii ssp. bulgaricus, Lactobacillus paracasei Streptococcus thermophilus, and combinations thereof.
12. The method of aspect 11, wherein the lactic acid bacteria is Lactobacillus plantarum.
13. The method of any preceding aspect comprising adding the lactic acid bacteria to the aqueous slurry or the pea protein base in an amount of about 0.1% to about 1% by weight, based on the total weight of the aqueous slurry or the pea protein base.
14. The method of any preceding aspect comprising subjecting the pea protein hydrolysate to fermentation for about 5 to about 10 hours at about 35° C. to about 40° C.
15. The method of any preceding aspect comprising sterilizing the aqueous slurry or the pea protein base subsequent to subjecting the pea protein hydrolysate to fermentation.
16. A flavour modifying ingredient obtainable by and/or obtained by the method of any of aspects 1 to 15.
17. The flavour modifying ingredient of aspect 16, wherein the flavour modifying ingredient is spray dried.
18. A flavour composition for food products comprising the flavour modifying ingredient of aspect 16 or 17, and at least one food grade excipient.
19. The flavour composition of aspect 18, wherein the flavour modifying ingredient is present in an amount of about 1% to about 20% based on the total weight of the flavour composition.
20. The flavour composition of aspect 18 or 19 further comprising one or more sweeteners.
21. The flavour composition of aspect 20, wherein the one or more sweeteners are selected from sucrose, fructose, glucose, arabinose, rhamnose, tagatose, allulose, trehalose, isomaltulose, steviol glycosides (e.g. rebaudioside A, rebaudioside B, rebaudioside C, rebaudioside D, rebaudioside M, stevioside), stevia, trilobatin, rebusoside, aspartame, advantame, agarve syrup, acesulfame potassium (AceK), high fructose corn syrup, neotame, saccharin, sucralose, high fructose corn syrup, starch syrup, Luo Han Guo extract, mogrosides, neohespiridin, dihydrochalcone, naringin, and sugar alcohols (e.g. sorbitol, xylitol, inositol, mannitol, erythritol).
22. A food product comprising the flavour modifying ingredient of aspect 16 or 17.
23. The food product of aspect 22, wherein the flavour modifying ingredient is present in an amount of about 1 ppm to about 100 ppm based on the total weight of the food product.
24. The food product of aspect 23, wherein the flavour modifying ingredient is present in an amount of about 0.1 ppm to about 20 ppm based on the total weight of the food product.
25. The food product of any one of aspects 22 to 24, wherein the food product is a citrus-flavoured beverage.
26. The food product of any one of aspects 22 to 25, further comprising one or more sweeteners.
27. The food product of aspect 26, wherein the one or more sweeteners are selected from sucrose, fructose, glucose, arabinose, rhamnose, tagatose, allulose, trehalose, isomaltulose, steviol glycosides (e.g. rebaudioside A, rebaudioside B, rebaudioside C, rebaudioside D, rebaudioside M, stevioside), stevia, trilobatin, rebusoside, aspartame, advantame, agarve syrup, acesulfame potassium (AceK), high fructose corn syrup, neotame, saccharin, sucralose, high fructose corn syrup, starch syrup, Luo Han Guo extract, mogrosides, neohespiridin, dihydrochalcone, naringin, and sugar alcohols (e.g. sorbitol, xylitol, inositol, mannitol, erythritol).
28. Use of a flavour modifying ingredient of claim 16 or 17 to improve the sweetness of a food product.
29. A method of modulating the sweetness of a food product, the method comprising the steps of admixing the flavour modifying ingredient of aspect 16 or 17 with a food product.
30. A citrus-flavoured beverage comprising a beverage base, citrus flavour and a sweetness modifying proportion of the flavour modifying ingredient of aspect 16 or 17.

### EXAMPLES

### Example 1—Preparation of Flavour Modifying Ingredient Using Pea Protein

A slurry was prepared with a pea protein isolate at 15% in water.

The pea protein in the slurry was then partially hydrolyzed with Umamizyme (Amano) added at 0.1 to 1% level for about 4 hours at 50° C.

The slurry was then heated to 121° C. for 45 minutes to eliminate any microbial contamination from the starting material and to inactivate the enzymes, and then fermented for about 24 hours with the cultures BB-12® (Bifidobacterium animalis lactis) or LGG® (Lactobacillus rhamnosus).

The initial pH of 6.18 decreased to 5.35 with LGG® and to 4.9 with BB-12®.

Final heat treatment of the sample was carried out at 121° C. for 15 minutes.

Sensory evaluation was carried out at 0.15% in a non-dairy yoghurt base by trained expert panellists. Both samples were deemed to provide a pleasant flavour and good mouthfeel properties.

### Example 2—Preparation of Flavour Modifying Ingredient Using Organic Pea Protein Isolate

A slurry was prepared with organic pea protein isolate (obtained from Puris, LLC of Wisconsin, USA) at about 18% in water with the addition of 0.1% NaCl.

The slurry was sterilized at 121° C. for 30 minutes to eliminate any microbial contamination from the starting material and allowed to cool down to 50° C.

The pea protein in the slurry was then hydrolyzed with Umamizyme (Amano) added at about 0.6% (or 4% enzyme-to-protein ratio) for about 16 hours at 50° C.

Glutaminase PG-500 (Amano) was then added at 0.02% (or 0.13% on protein) and the process continued for another 2 hours at 50° C.

The slurry was then cooled down to 37° C. and inoculated with Lb plantarum added at about 0.3% and incubated for 6 hours at 37° C. with minimal agitation.

Final sterilization of the slurry was at 121° C. for 45 minutes.

The ingredient can be used as is or after further stabilization with propylene glycol (30%).

### Example 3—Citrus Flavoured Beverage Containing Flavour Modifying Ingredient

A citrus flavoured beverage was prepared using a stevia/sugar hybrid base comprising 3% sucrose, 0.05% citric acid and 0.008% Rebaudioside A in water.

The Flavour Modifying Ingredient made according to the process described in Example 2 was added to the citrus flavoured beverage at a concentration of 1 ppm.

Organoleptic evaluation of the modified citrus flavoured beverage was undertaken by sensory trained expert panellists. The panellists found that the modified citrus flavoured beverage provided a pleasant sugary taste and mouthfeel. The organoleptic descriptors/comments used/provided by the panellists were: masks off-notes, adds mouthfeel, and increases sugary body. The sugar-like taste is very desirable in carbonated soft drinks with reduced/partially replaced sugar. The citrus flavoured beverage also had a low caloric value due to the sugar blend (stevia/sugar hybrid base) used to prepare the beverage.

### Example 4—Plant-Based Protein Beverage Containing Flavour Modifying Ingredient

A plant-based protein beverage was prepared using 3% sucrose, 3% pea protein and 0.03% gellan gum in water.

The Flavour Modifying Ingredient made according to the process described in Example 2 was added to the plant-based protein beverage at a concentration of 1 ppm.

Organoleptic evaluation of the modified plant-based protein beverage was undertaken by sensory trained expert panellists. The panellists found that the modified plant-based protein beverage provided a pleasant taste and mouthfeel. The organoleptic descriptors/comments used/provided by the panellists were: masks off-notes, adds mouthfeel, and increases sugary body.

### Example 5—Lemon Lime Carbonated Soft Drink Containing Flavour Modifying Ingredient

A lemon lime carbonated soft drink (100 calories) was prepared having the following composition:

| Ingredient | Amount (g/L) |
|---|---|
| Sodium benzoate | 0.065 |
| Sodium citrate | 0.25 |
| Citric | 1.525 |
| Lemon lime flavour | 0.8 |
| Sugar | 70.47 |
| Acesulfame potassium | 0.042 |
| Sucralose | 0.061 |
| Water | 951.74 |

The Flavour Modifying Ingredient made according to the process described in Example 2 was added to the lemon lime carbonated soft drink at a concentration of 1 ppm.

Organoleptic evaluation of the lemon lime carbonated soft drink without the flavour modifying ingredient (control) and the modified lemon lime carbonated soft drink containing the flavour modifying ingredient was undertaken by sensory trained expert panellists. The panellists found that:
the modified lemon lime carbonated soft drink had a better upfront sweet impact, brighter flavour and thinner body as compared to the control.
the modified lemon lime carbonated soft drink had a good sweet, clean finish and did not impart an unpleasant lingering sweetness which was present in the control.
the modified lemon lime carbonated soft drink provided a reduced “artificial” sweet peak to be closer to the taste of sucrose (sugar) as compared to the control.
the modified lemon lime carbonated soft drink was more sugary with a strong sugar cane character as compared to the control.

Example 6—Lemon Lime Carbonated Soft Drink Containing Flavour Modifying Ingredient

A lemon lime carbonated soft drink (100 calories) was prepared having the following composition:

| Ingredient | Amount (g/L) |
|---|---|
| Sodium benzoate | 0.065 |
| Sodium citrate | 0.25 |
| Citric | 1.525 |
| Lemon lime flavour | 0.96 |
| Sugar | 70.47 |
| Stevia | 0.1 |
| Water | 951.74 |

The Flavour Modifying Ingredient made according to the process described in Example 2 was added to the lemon lime carbonated soft drink at a concentration of 1 ppm.

Organoleptic evaluation of the lemon lime carbonated soft drink without the flavour modifying ingredient (control) and the modified lemon lime carbonated soft drink containing the flavour modifying ingredient was undertaken by sensory trained expert panellists. The panellists found that:
the modified lemon lime carbonated soft drink had a cleaner finish as compared to the control.
the modified lemon lime carbonated soft drink had a very clean, well rounded, and enhanced flavour profile as compared to the control.
the modified lemon lime carbonated soft drink had a rounded sweetness and significantly reduced bitter off-taste as compared to the control.
the modified lemon lime carbonated soft drink had a more “lemony” fruity finish as compared to the control.

### Example 7—Non-Dairy Chocolate Protein Shake (25g protein) Containing Flavour Modifying Ingredient

The Flavour Modifying Ingredient made according to the process described in Example 2 was added to a Muscle Milk® (Pepsico; Purchase, New York) non-dairy chocolate protein shake at a concentration of 1 ppm.

Organoleptic evaluation of the non-dairy chocolate protein shake without the flavour modifying ingredient (control) and the modified non-dairy chocolate protein shake containing the flavour modifying ingredient was undertaken by sensory trained expert panellists. The panellists found that:
the modified non-dairy chocolate protein shake had a cleaner finish, lower chalky off-notes, and a richer and sweeter chocolate taste and mouthfeel as compared to the control.
the modified non-dairy chocolate protein shake had reduced bitterness and astringency, and a cleaner aftertaste as compared to the control.

The organoleptic descriptors/comments used/provided by the panellists were: more chocolate flavour, and less chalky.

### Example 8—Plant-Based Chocolate Protein Shake (20g protein) Containing Flavour Modifying Ingredient

The Flavour Modifying Ingredient made according to the process described in Example 2 was added to an Evolve® (Pepsico; Purchase, New York) plant-based chocolate protein shake at a concentration of 1 ppm.

Organoleptic evaluation of the plant-based chocolate protein shake without the flavour modifying ingredient (control) and the modified plant-based chocolate protein shake containing the flavour modifying ingredient was undertaken by sensory trained expert panellists. The panellists found that:
the modified plant-based chocolate protein shake had reduced bitterness and astringency as compared to the control.
the modified plant-based chocolate protein shake had reduced earthy off-notes as compared to the control.
the modified plant-based chocolate protein shake had more overall aroma as compared to the control.

### Example 9—Fermentation Study

Fermentation trials were run on a nondairy yogurt base, namely a pea protein base, using different microbial cultures. The objective of the trials was to determine the correct pH range in a good timeline. The nondairy base contained in %weight (g) 75.74% water, 13.30% pea protein isolate (PURIS® P870), 9.00% UHT coconut cream, 1.00% cane sugar, 0.50% calcium complex, 0.050% citrus fiber (CITRI-FI 100M40; 200MESH), and 0.010% pea protein binder. The nondairy base was prepared according to the following steps: i) adding pea protein isolate and pea protein binder flavor to water at 55-60° C.; ii) hydrating protein with water for 30 minutes with high shear at 55-60° C.; iii) mixing all dry ingredients and adding while hydrating protein; iv) melting and adding coconut fat and continue mixing for 15 minutes; v) heating the slurry to 62° C.; vi) homogenizing at 2500/500 psi; vii) heat treating at 95° C. for 8 minutes; and viii) cooling to 40° C.

Two cultures were formulated with the following microbial strains: Lactobacillus delbrueckii subsp. bulgaricus, Streptococcus thermophilus, Lactobacillus acidophilus, and Bifidobacterium ssp. The strains were classified per their characteristics but there were differences in their plasmid profile that dictate some of their functional characteristics like viscosity production and ability to ferment lactose, and phage sensitivity/resistance. Culture 1 (C1- ABY421 from Vivolac) ferments very slow and gives high viscosity with a very mild almost neutral flavour. Culture 2 (C2- ABY424 from Vivolac) is a faster acid producer with high viscosity and a slightly stronger acetaldehyde (yogurt flavour).

### Tests Performed

Base Testing—The pH of the base was tested to be 6.87 at refrigeration temperature. The base was also plated for the presence of coliform and standard plate count. The percent of solids was determined to be 18.43%.

Overnight Fermentation Procedure:
Ten 150 mL samples of the nondairy yogurt base were allotted in sterile jars.
Two 150 mL samples of ultra-high-temperature (UHT) milk (shelf stable) were allotted in sterile jars.
One set of five of the nondairy yogurt base samples and 1 UHT milk sample were tempered at 40° C. and the other set at 42° C.
Samples were inoculated at a rate of 0.4% with the ratios listed in Table 1 and agitated to blend small amounts of each of the UHT milk and nondairy yogurt base in sterile jars were added as uninoculated controls.
Samples were incubated for 16 hours.
pH's were measured at the end of 16 hours.

TABLE 1
Overnight Fermentation Culture Ratios and pH’s after 16 hours.

| | | | | pH at the |
|---|---|---|---|---|
| | | | Fermentation | end of |
| Sample | Base | Culture Ratio | Temp. (° C.) | 16 hrs. |
| 1 | nondairy | 100% C1 | 40 | 4.64 |
| | yogurt base | | | |
| 2 | nondairy | 100% C2 | 40 | 4.37 |
| | yogurt base | | | |
| 3 | nondairy | 50%/50% C1 to C2 | 40 | 4.49 |
| | yogurt base | | | |
| 4 | nondairy | 70%/30% C1 to C2 | 40 | 4.54 |
| | yogurt base | | | |
| 5 | nondairy | 30%/70% C1 to C2 | 40 | 4.51 |
| | yogurt base | | | |
| 6 | UHT milk | 50%/50% C1 to C2 | 40 | 3.92 |
| 7 | nondairy | 100% C1 | 42 | 4.58 |
| | yogurt base | | | |
| 8 | nondairy | 100% C2 | 42 | 4.32 |
| | yogurt base | | | |
| 9 | nondairy | 50%/50% C1 to C2 | 42 | 4.46 |
| | yogurt base | | | |
| 10 | nondairy | 70%/30% C1 to C2 | 42 | 4.50 |
| | yogurt base | | | |
| 11 | nondairy | 30%/70% C1 to C2 | 42 | 4.43 |
| | yogurt base | | | |
| 12 | UHT milk | 50%/50% C1 to C2 | 42 | 3.85 |

Uninoculated controls for both the UHT milk and the nondairy yogurt base did not acidify after 16 hours of incubation.

### Daytime Fermentation Procedure:

Two 150 mL samples of the nondairy yogurt base were allotted in sterile jars.
One 150 ml sample of UHT milk was allotted in a sterile jar.
Samples were tempered to 40° C.
Samples were inoculated at a rate of 0.4% with the ratios listed in Table 2 and agitated to blend.
Small amounts of each of the UHT milk and the nondairy yogurt base in sterile jars were added as uninoculated controls.
Samples were incubated at 40° ° C.for 7½ hours.
PH levels were measured at hour 5 and every half hour to 7½ hours or until a pH of 4.4 was reached.

TABLE 2
Daytime Fermentation Culture Ratios

| | | | Fermentation |
|---|---|---|---|
| Sample | Base | Culture Ratio | Temp. (° C.) |
| 1 | nondairy | 100% C2 | 40 |
| | yogurt base | 50%/50% C1 to C2 | 40 |
| 2 | nondairy | | |
| | yogurt base | 50%/50% C1 to C2 | 40 |
| 3 | UHT milk | | |

TABLE 3
Daytime Fermentation pH’s

| | | 50%/50% | |
|---|---|---|---|
| | 100% C2 | C1 to C2 | 50%/50% |
| | nondairy | nondairy | C1 to C2 |
| Time (hr) | yogurt base | yogurt base | UHT Milk |
| 5 | 4.89 | 4.90 | 4.37 |
| 5.5 | 4.77 | 4.80 | — |
| 6 | 4.69 | 4.74 | — |
| 6.5 | 4.63 | 4.71 | — |
| 7 | 4.58 | 4.70 | — |
| 7.5 | 4.55 | 4.66 | — |

The activity of the 50%/50% C1 to C2 in UHT milk reached pH 4.4 within 5 hours, however in the nondairy yogurt base the activity at the same inoculation ratio reached pH 4.66 in 7½ hours. The 100% C2 inoculation into the nondairy yogurt base reached pH 4.55 in 7½ hours. Uninoculated controls for both the UHT milk and the nondairy yogurt base did not acidify after 7½ hours of incubation.

### Conclusion

Uninoculated control base samples did not drop in pH in either fermentation, indicating there was not acid producing bacteria present in the base itself. The culture activity was slower when inoculated at the same rates in the nondairy yogurt base compared to UHT milk. Activities of samples fermented at 42° C. were faster than samples fermented at 40° C. The 100% C2 activities were faster than the 100% C1 activities. Blends of the two cultures gave different fermentation speeds according to the ratio of microbial strains inoculated. Blends with higher ratio of C2 were faster than blends with less C2 (and more C1). The samples that reached pH 4.4 were the 16 hour fermentations of 100% C2 at both temperatures. The next closest sample to reaching pH 4.4 in 16 hours was the 30%/70% C1/C2 fermented at 42° C. Some difference in curd size was seen. C1 produced smooth curds with small size and good mouthfeel.

TABLE 4
Illustrative dairy free Microbial Cultures used to make
Ready-to-Eat and Ready-to-Drink Products

| General ID # | Component | Strain(s) |
|---|---|---|
| 716593 | F-DVS-BB-12 | Bifidobacterium animalis lactis |
| 716594 | F-DVS L. Casei 431 | Lactobacillus paracasei |
| 720758 | F-DVS-LGG | Lactobacillus rhamnosus |
| 704993 | YF-L01 DA | Streptococcus thermophilus |
| 716628 | YF-L02 DA | Streptococcus thermophilus and |
| | | Lactobacillus bulgaricus |
| — | ABY 421 ND | Lactobacillus delbrueckii |
| | | subsp. bulgaricus, |
| | | Streptococcus thermophilus, |
| | | Lactobacillus acidophilus, and |
| | | Bifidobacterium ssp. |
| — | ABY 424 ND | Lactobacillus delbrueckii |
| | | subsp. bulgaricus, |
| | | Streptococcus thermophilus, |
| | | Lactobacillus acidophilus, |
| | | and Bifidobacterium ssp. |
| | B019 | Bifidobacterium animalis subsp. lactis |
| | | (Probiotic BifidoB HN019) |

The first five microbial cultures listed in Table 4 (i.e., 716593, 716594, 720758, 704993 and 716628) were obtained from Chr. Hansen A/S of Hørsholm, Denmark. The remaining two microbial cultures listed in Table 4 (i.e., ABY 421 ND and ABY 424 ND) were obtained from Vivolac Cultures Corporation of Indiana, USA. It has been found that the cell surface structures of Bifidobacterium animalis lactis (BB-12®) and Lactobacillus rhamnosus (LGGR) provide good mouthfeel and texture in flavour applications.

### Example 10—Further Sensory Evaluation of Strain or Blend of Strains

Fermentation was continued with the strain or blend of strains of Samples 7, 8, 9 and 11 (as detailed in Table 1 of Example 9). Two to three samples of each strain or blend of stains were taken at different pH levels and evaluated for sensory properties to find an optimum solution, which closely represents dairy alternatives. Pre-acidify the water between 5-6 pH before fermentation and review sensory properties. Increase the sugar and culture to find out how it impacts the pH and sensory properties.

### Example 11—Fermentation of Chickpea Flour

A slurry was prepared with chickpea flour (Organic Chickpea Flour obtained from Cambridge Commodities Inc. of California, USA or Firebird Artisan Mills of North Dakota, USA) at 10% in water. The slurry was sterilized at 121° C. for 45 minutes to eliminate any microbial contamination from the starting material and allowed to cool down to 37° C. The slurry was then inoculated with LGGR (Lactobacillus rhamnosus) or BB-12® (Bifidobacterium animalis lactis) or YOFLEX® YF-L01 DA (Streptococcus thermophilus) or YOFLEX® YF-L02 DA (Lactobacillus bulgaricus) or L. Casei 431 (Lactobacillus paracasei) added at 0.4% and incubated for 24 hours at 30-37° C. with minimal agitation. The final slurry was then heated at 121° C. for 15 minutes. The initial pH of around 6 had dropped to below 4 in all the cases except when LGG® was used, wherein the final pH was around 5. Sensory evaluation of the fermented chickpea flour at 0.15% was carried out with trained expert panellists in vegan Alfredo sauce and in a bland, non-dairy sauce. The organoleptic descriptors used by the panellists for the vegan Alfredo sauce were: adds creamy, dairy notes, as well as salty, umami, brothy; masks the beany off-notes from the base. The organoleptic descriptors used by the panellists for the bland, non-dairy sauce were: creamy and nice mouthfeel with cultured/dairy impression. These flavour modifiers can be formed into ready-to-eat and/or ready-to-drink products by modifying the level of solid starting material and adjusting the process with the final inactivation of the microorganisms being optional.

The foregoing broadly describes certain embodiments of the present invention without limitation. Variations and modifications as will be readily apparent to those skilled in the art are intended to be within the scope of the present invention as defined in and by the appended claims.

1. A method for making a flavour modifying ingredient, the method comprising the steps of:
i. forming an aqueous slurry of a pea protein;
ii. subjecting the pea protein to enzymatic hydrolysis using one or more proteolytic enzymes to form a pea protein hydrolysate;
iii. subjecting the pea protein hydrolysate to fermentation using one or more lactic acid bacteria selected from the group consisting of Lactobacillus paracasei, Lactobacillus casei, Lactobacillus rhamnosus, Lactobacillus bulgaricus, Lactobacillus delbrueckii subsp. bulgaricus, Lactobacillus acidophilus, Lactobacillus plantarum, Lactiplantibacillus plantarum, Lactobacillus brevis, Lactobacillus helveticus, Bifidobacterium, Bifidobacterium animalis lactis and/or Streptococcus thermophilus

2. The method of claim 1, wherein the pea protein is selected from the group consisting of: pea protein liquor, pea protein isolate, pea protein concentrate, pea flour, and mixtures thereof.

3. The method of claim 1, wherein the pea protein is present in an amount of about 10% to about 30% by weight, based on the total weight of the aqueous slurry.

4. The method of claim 1 further comprising sterilizing the aqueous slurry prior to forming the pea protein hydrolysate.

5. The method of claim 1, wherein the one or more proteolytic enzymes are selected from the group consisting of proteinase, peptidase, glutaminase, and mixtures thereof.

6. The method of claim 1 comprising using two or more proteolytic enzymes.

7. The method of claim 1, comprising hydrolyzing the pea protein with a first proteolytic enzyme for about 10 to about 20 hours at about 40° C. to 60° C., followed by hydrolyzing the pea protein with a second proteolytic enzyme for about 1 to about 5 hours at about 40° C. to 60° C., wherein the first proteolytic enzyme is different than the second proteolytic enzyme.

8. The method of claim 1, wherein the lactic acid bacteria is selected from the group consisting of: Lactobacillus plantarum, Lactobacillus casei, Lactobacillus paracasei, Lactobacillus brevis, Lactobacillus helveticus, L. delbrueckii ssp. bulgaricus, Streptococcus thermophilus, Lactobacillus acidophilus, Bifidobacterium, Lactobacillus rhamnosus and combinations thereof, preferably a combination comprising Bifidobacterium, Lactobacillus acidophilus, L. delbrueckii ssp. bulgaricus, Lactobacillus paracasei Streptococcus thermophilus, and combinations thereof.

9. The method of claim 1 comprising adding the lactic acid bacteria to the aqueous slurry in an amount of about 0.1% to about 1% by weight, based on the total weight of the aqueous slurry.

10. The method of claim 1 comprising subjecting the pea protein hydrolysate to fermentation for about 5 to about 10 hours at about 35° C. to about 40° C.

11. A flavour modifying ingredient obtainable by and/or obtained by the method of claim 1.

12. A flavour composition for food products comprising the flavour modifying ingredient of claim 11, and at least one food grade excipient.

13. A food product comprising the flavour modifying ingredient of claim 11.

14. The food product of claim 13, wherein the food product is a citrus-flavoured beverage.

15. The food product of claim 13 further comprising one or more sweeteners.

16. A method of utilizing a flavour modifying ingredient of claim 11 to improve the sweetness of a food product.

17. A method of modulating the sweetness of a food product, the method comprising the steps of admixing the flavour modifying ingredient of claim 11 with a food product.
